(19) United States
(12) Patent Application Publication
(10) Pub. No.: US 2021/0108034 A1
(43) Pub. Date: Apr. 15, 2021

(54) THERMOCHEMICAL BIOMASS COMPOUNDER

(71) Applicant: The United States of America, as Represented by the Secretary of Agriculture, Washington, DC (US)

(72) Inventors: ZACHARIAH MCCAFFREY, DAVIS, CA (US); LENNARD F TORRES, DUBLIN, CA (US); MARK WECHSLER, SAN MATEO, CA (US)

(21) Appl. No.: 17/066,688

(22) Filed: Oct. 9, 2020

Related U.S. Application Data
(60) Provisional application No. 62/914,045, filed on Oct. 11, 2019.

(51) Int. Cl. C08J 3/00; B01J 6/00; C08H 8/00; C08L 23/06; C08L 97/02

(52) U.S. Cl. CPC C08J 3/005; B01J 6/00; C08H 8/00; C08L 23/06; C08L 2207/064; C08J 2323/06; C08J 2497/02; C08J 2397/02; C08J 2423/06; C08L 97/02

(57) ABSTRACT

A system, optionally a continuous-process system, for the production of a biomass-polymer composite. The system accepts a biomass input, particulates the biomass using one or more mills, subjects the particulated biomass to a heat treatment, such as torrefaction, and then compounds the torrefied biomass with a polymer to create the composite. Such a system, and in particular, a continuous-type system, allows for efficient processing of all of the inputs, and furthermore eliminates the dangers, time, and costs associated with having to safely cool down torrefied biomass prior to compounding at a later time or location.

### REFERENCE TO RELATED APPLICATIONS

This application claims the benefit of U.S. Provisional Application No. 62/914,045, filed Oct. 11, 2019, which is incorporated herein by reference in its entirety.

### BACKGROUND

Due to a growing public concern for the reduction of greenhouse gases, there is recent focus on the utilization of biomass (e.g., forest trimmings, farming residues and agricultural wastes, animal byproducts, food waste, etc.) as additives for commodity plastics. Biomass-reinforced plastic composites have been developed for many applications mainly because biomass is derived from sustainable, natural resources and therefore can reduce greenhouse gas emissions. The advantages of biomass additives in thermoplastic composites are that they are non-abrasive, low cost, sustainable, and may lower the density of the final product.

One disadvantage of this approach is the hydrophilic nature of raw biomass materials. Biomass mainly contains hemicellulose, amorphous and crystalline cellulose, lignin, and, to some extent, volatile organic acids and oils. The hydrophilic nature of the hemicellulose and amorphous cellulose components makes the biomass incompatible with hydrophobic commodity plastics, resulting in poor interfacial adhesion between the natural fibers and the polymer matrix.

Another disadvantage is the poor thermal properties of the raw biomass, which can degrade during melt-blending with commodity plastics. Without pretreatment, the processing temperatures of thermoplastics can lead to degradation of the biomass, which may negatively affect the overall mechanical properties of the resulting biomass composite. Finally, to some extent, off-gassing (i.e., elimination of volatile materials) may also occur which can be problematic during biomass composite production. To overcome the limitations that give composites poor functionality, it is often necessary for the raw biomass to undergo a pretreatment to remove volatile components.

Torrefaction and carbonization (i.e., pyrolysis) are thermal processes that thermally break down raw biomass at temperatures between 180-650° C. in the absence of oxygen. Hemicellulose within biomass typically degrades most readily during thermal processing, resulting in a hydrophobic biomass comprising primarily crystalline cellulose and lignin. The increase in hydrophobicity of biomass with thermal treatment improves the adhesion between the plastic and biomass filler. Moreover, the addition of a more hydrophobic biomass hinders the absorption of moisture, which may prevent mold growth (especially in cases of high biomass filler concentrations) and maintain structural integrity longer than a composite with raw biomass filler. Thus, the solid product of the torrefaction process is ideal for use in the manufacture of biomass composites.

Typically, the manufacture of a biomass composite involves a series of separate operations. The first step deals with the torrefaction of the raw biomass, which results in a solid product that requires rapid cooling to ambient temperature. The second step includes grinding the thermally-treated biomass to a specific particle size and then storing it until it is to be coextruded with plastics. The final step involves compounding the thermally-treated biomass with a thermoplastic using an extruder at temperatures above the softening point of the plastic. The heated biomass-polymer composite is extruded into rods, which are then pelletized into short lengths. The biomass-polymer composite pellets can then be used in injection molding or other industrial polymer processes.

Despite its potential, there are several issues for the aforementioned method and system for the manufacture of thermally-treated biomass composites. One key issue is cooling the newly thermally-treated biomass prior to storage and transportation between operations. Without complete control of the cooling stage after thermal treatment, a single ember can ignite and burn the entire stockpile, a frequent problem encountered in industry. A second issue is the handling and transport of fine particles. The brittleness of the material can result in large amounts of dust, thus increasing the risk for dust explosions. Finally, unless the torrefaction facility is near the plastic compounder, the costs for shipping and handling, as well as the carbon footprint, increases.

Thus, there is a need for an integrated heat-treatment and compounding system for the manufacture of biomass-polymer composites for use as an intermediate product in various plastics applications.

All of the references cited herein, including U.S. patents and U.S. Patent Application Publications, are incorporated by reference in their entirety.

Mention of trade names or commercial products in this publication is solely for the purpose of providing specific information and does not imply recommendation or endorsement by the U.S. Department of Agriculture.

### SUMMARY

The present invention relates to a system, optionally a continuous-process system, for the production of a biomass-polymer composite. The system accepts a biomass input, particulates the biomass using one or more mills, subjects the particulated biomass to a heat treatment, such as torrefaction, and then compounds the torrefied biomass with a polymer to create the composite. Such a system, and in particular, a continuous-type system, allows for efficient processing of all of the inputs, and furthermore eliminates the dangers, time, and costs associated with having to safely cool down torrefied biomass prior to compounding at a later time or location.

According to at least one aspect of the invention, a system for the production of a biomass-polymer composite may include a mill configured to accept a biomass input, a torrefaction reactor, and a compounder. The mill may be configured to generate a particulated biomass from the biomass input, the particulated biomass having a particle size of between about 1 to about 1000 microns; the torrefaction reactor may be configured to conduct a heat treatment of the particulated biomass, the heat treatment comprising exposing the particulated biomass to a temperature of between about 180 to about 650° C. to generate a torrefied biomass; the compounder may be configured to combine the torrefied biomass with a plastic to generate the biomass-polymer composite; and the torrefaction reactor and the compounder may be in functional communication with each other to permit the torrefied biomass to flow from the torrefaction reactor to the compounder without allowing the torrefied biomass to cool to a temperature below 100° C.

According to a further embodiment of the invention, the system may also include a first feeder disposed between the mill and the torrefaction reactor, the first feeder being configured to provide a controlled flow of the particulated biomass into the torrefaction reactor.

According to a further embodiment of the invention, the system may also include a second feeder disposed between the torrefaction reactor and the compounder, the second feeder being configured to provide a controlled flow of the torrefied biomass into the compounder.

According to further embodiments of the invention, the mill may include an attrition mill and/or a ball mill, and the particulated biomass may have a particle size of between about 1 to about 150 microns.

According to further embodiments of the invention, the heat treatment may have a duration of between about 1 to about 100 minutes, and may be conducted in a low-oxygen or oxygen-free environment.

According to a further embodiment of the invention, the compounder may be configured to combine the torrefied biomass with the plastic in a melt blend at a temperature near the melting point of the plastic.

According to at least another embodiment of the invention, a method for the production of a biomass-polymer composite may include providing a biomass input, reducing the particle size of the biomass input to create a particulated biomass, conducting a heat treatment of the particulated biomass to create a torrefied biomass, and combining the torrefied biomass with a plastic to create a biomass-polymer composite. The particulated biomass may have a particle size of between about 1 to about 1000 microns; the heat treatment of the particulated biomass may include exposing the particulated biomass to a temperature of between about 180 to about 650° C.; and the torrefied biomass may not be substantially cooled prior to being combined with the plastic.

According to further embodiments of the invention, the reducing of the particle size of the biomass input may be conducted with an attrition mill and/or a ball mill, and the particulated biomass may have a particle size of between about 1 to about 150 microns.

According to further embodiments of the invention, the heat treatment of the particulated biomass may have a duration of between about 1 to about 100 minutes, and it may be conducted in a low-oxygen or oxygen-free environment.

According to further embodiments of the invention, the combining of the torrefied biomass with the plastic may be conducted in an extruder, and/or the combining of the torrefied biomass with the plastic may be conducted in a melt blend at a temperature near the melting point of the plastic.

### BRIEF DESCRIPTION OF THE FIGURES

Advantages of embodiments of the present invention will be apparent from the following detailed description of the exemplary embodiments.

The following detailed description should be considered in conjunction with the accompanying figures in which:

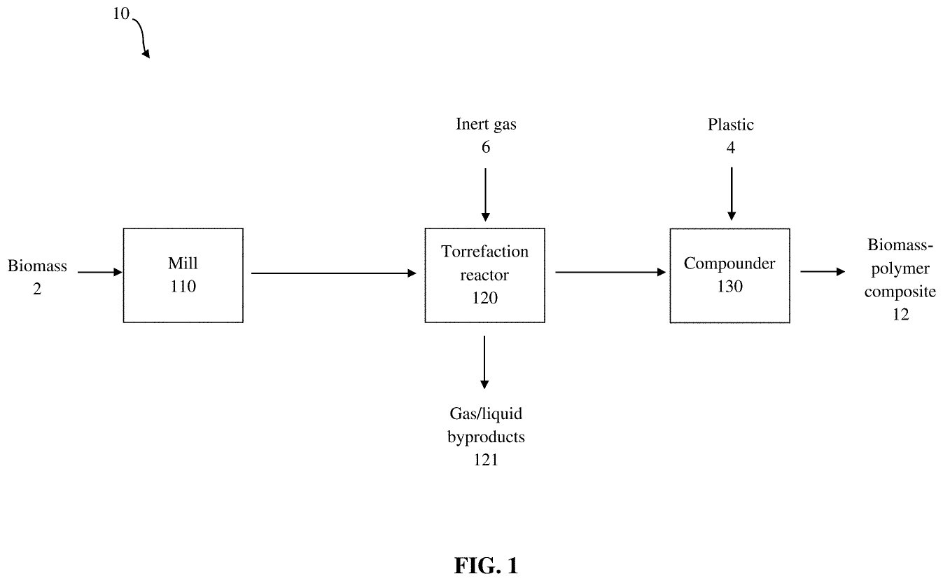

Exemplary FIG. 1 shows a schematic of a system for the production of a biomass-polymer composite.

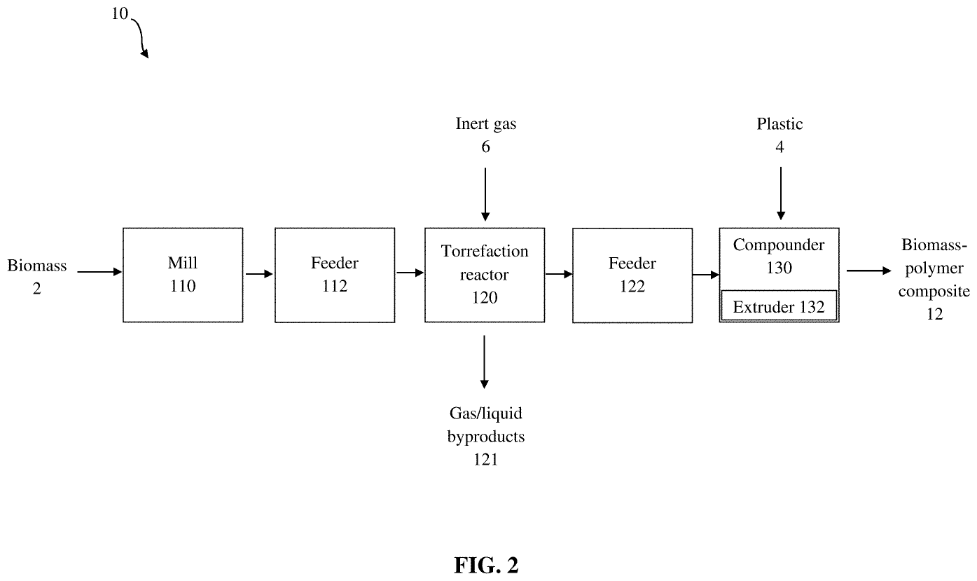

Exemplary FIG. 2 shows a schematic of a system for the production of a biomass-polymer composite, with additional optional components as in comparison to FIG. 1. These optional components may exist separately or together in an exemplary system according to the present invention.

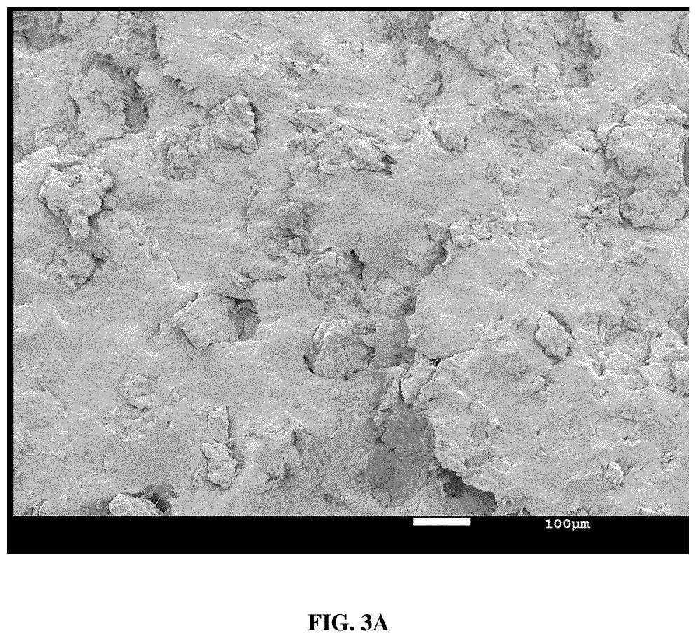

Exemplary FIGS. 3A and 3B show two views of scanning electron micrographs (SEM) of biomass-polymer composite produced according to the present invention.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Unless defined otherwise, all technical and scientific terms used herein have the same meaning as commonly understood by one of ordinary skill in the art to which the invention belongs. As used herein, the term “about” refers to a quantity, level, value, or amount that varies by as much as 30%, preferably by as much as 20%, and more preferably by as much as 10% to a reference quantity, level, value, or amount. Although any methods and materials similar or equivalent to those described herein can be used in the practice or testing of the present invention, the preferred methods and materials are now described.

As used herein, “biomass” refers to organic plant-based residues. In particular, it refers to plant-based material which contains a high percentage of lignocellulosic material, and may refer to a whole plant or parts thereof, such a fibers from a plant or plant part. Examples of biomass useable in the present invention include, but are not limited to, fibers rice straw, wheat straw, cotton, corn and corn stover, yellow pine, nut hulls and shells, including from almonds and walnuts, and other agricultural residue and forest litter.

As used herein, a “biomass-polymer composite” refers to a material made from the combination of biomass and a thermoplastic, wherein the biomass and thermoplastic are mechanically, but not chemically, bound to each other. The thermoplastic may be any suitable thermoplastic for a desired use, and may include polyethylene, polypropylene, polystyrene, polyethylene terephthalate, polylactic acid, polyhydroxybutyrate, bioplastics, and a combination thereof. Moreover, the thermoplastic can be non-recycled or recycled (reclaimed).

Other compounds may be added to the composite provided they do not substantially interfere with the intended activity and efficacy of the composition; whether or not a compound interferes with activity and/or efficacy can be determined, for example, by the procedures utilized below.

The amounts, percentages, and ranges disclosed herein are not meant to be limiting, and increments between the recited amounts, percentages, and ranges are specifically envisioned as part of the invention.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The invention illustratively disclosed herein suitably may be practiced in the absence of any element (e.g., method (or process) steps or composition components) which is not specifically disclosed herein.

Referring to exemplary FIG. 1, a thermochemical biomass compounder system 10 for the production of a biomass-polymer composite 12 from biomass 2 and a plastic 4 may include the use of a mill 110, a torrefaction reactor 120, and a compounder 130. The input biomass 2 may be provided to mill 110 for the reduction of the particle size of the biomass. Mill 110 may be, for example, an attrition mill. The particulated biomass output of mill 110 may then be provided as an input for torrefaction reactor 120. Inert gas 6 may also be provided to torrefaction reactor 120 to provide for a low-oxygen or oxygen-free environment within torrefaction reactor 120. Torrefaction reactor 120 may process the particulated biomass in a heat treatment, thus creating a torrefied biomass solid product and one or more gaseous and/or liquid byproducts 121. The torrefied biomass may then be fed to a compounder 130 together with plastic 4, and compounder 130 may then combine the torrefied biomass and plastic 4 to create a biomass-polymer composite 12.

According to some aspects of the invention, mill 110, which may also be referred to as a mill assembly, may include multiple sub-mills to gradually reduce the particle size of the biomass. Further, mill 110 may be an attrition mill equipped with ceramic balls to achieve the particle size reduction. In addition, mill 110 may reduce the particle size of the biomass to between about 1 micron and about 1000 microns. The particle size of the output of mill 110 may be as small as desired for a particular application. For example, the particle size of the biomass may be between about 1 and about 10000 microns, between about 1 and about 500 microns, 150 microns, 100 microns, 50 microns, or any other size, as desired. According to some aspects of the invention, and as shown in exemplary FIG. 2, the particulated biomass output of mill 110 may be fed to a feeder 112. Feeder 112 may be a gravimetric, volumetric, or any other type of feeder which provides a controlled flow of the particulated biomass to torrefaction reactor 120.

Torrefaction reactor 120 may provide for a heat treatment of the particulated biomass. Heat treatment may be applied by any convention or known method, including direct or indirect heating, radiation, friction, microwave, etc. The heat treatment may be performed under a low-oxygen or oxygen-free environment. Further, the heat treatment may be performed by subjecting the particulated biomass to a temperature between about 180 to about 650 degrees Celsius for a duration of between about 1 to about 100 minutes. In addition, the heat treatment may be performed in a continuous manner, for example in an extruder reactor. In at least one embodiment, the screw of the extruder of the torrefaction reactor may be set to achieve a torrefaction duration of about 4 to 5 minutes.

The torrefied biomass may vary in color from light brown to black, depending on temperature and duration of the torrefaction reaction. In addition, the pH of the torrefied biomass may vary, increasing with increasing torrefaction duration and/or temperature. Further, the torrefied biomass may be hydrophobic.

The torrefaction reaction may create gas and/or liquid byproducts 121. Gaseous byproducts may include carbon monoxide, carbon dioxide, light acids, methanol, and water. The gaseous byproducts may be collected and/or used in other applications, such as in a combustion to heat the particulated biomass.

As shown in exemplary FIG. 2, the torrefied biomass may be fed directly from torrefaction reactor 120 to a feeder 122. Feeder 122 may be a gravimetric, volumetric, or any other type of feeder which provides a controlled flow of the torrefied biomass to compounder 130. It is noted that whether or not feeder 122 is present in an embodiment of the invention, the torrefied biomass flows into compounder 130 without substantially cooling down.

The amount of cooling of the torrefied biomass prior to compounding may vary, depending on the materials used and/or the desired properties of the end product. For example, as stated above, the heat treatment may use temperatures from about 180 to about 650° C., and the processing temperature for many thermoplastics falls in the range of 150-300° C. Thus, some minimal cooling may be desired (i.e. from 600° C. to 200° C.), and the incidental loss of some heat due to imperfect insulation may contribute to that, but the system functions without the need to cool the material below 150° C., and at no time would the torrefied biomass be cooled below 100° C. prior to entering the compounder.

Compounder 130 may accept inputs of the torrefied biomass and plastic 4 to create the biomass-polymer composite 12. Compounder 130 may include an extruder 132 in which the biomass-polymer composite 12 is produced. Extruder 132 may melt blend plastic 4 with the torrefied biomass at a temperature near the melting point of plastic 4. The relative concentrations of polymer and biomass in the resulting biomass-polymer composite 12 may be varied by controlling the input from feeder 122 and/or of plastic 4.

According to several aspects of the invention, the biomass-polymer composite may be used in the creation of various articles of manufacture and in different industrial processes. These uses include, but are not limited to, extruding, injection molding, fiber forming, sheet forming, blow-molding, and thermoforming for the purpose of the creation of articles including cutlery, spun fibers, containers for packaging and hot server items (e.g., cups for hot or boiling liquids like tea or coffee), hard plastic casings (e.g., computers, car parts, etc.), and other items. It should be appreciated that a person of ordinary skill in the art may select any suitable process to create any article of manufacture from the biomass-polymer composites of the present invention.

### Example 1: Production of Biomass-Polymer Composite

An exemplary thermochemical biomass compounder system was constructed and included the following components: (1) an attrition mill assembly, which is represented by a knife mill and a Union Process ball mill attritor; (2) a first gravimetric feeder for conveying particulated biomass into a torrefaction reactor at a controllable mass rate; (3) a torrefaction reactor, which can transport biomass through zoned heaters at a controllable mass flow; (4) a second gravimetric feeder for conveying plastic pellets into a compounder at a controllable mass rate; (5) a compounder, including an extruder for compounding plastic with torrefied biomass, which mixes the plastic and torrefied biomass at an elevated temperature near the melting point of plastic to produce a well-mixed, well-dispersed biomass-polymer composite through a strand die to shape the product; (6) various subassemblies and interconnects to facilitate gas-tight seal of the process; (7) an off-gas handling system for collection and disposal of volatile gases and condensables; and (8) a plastic cooling system. Also used in the experiment was a pelletizer, usable to cut the composite strand into spherical pellets of approximately 3 mm in diameter; and an injection molder (Boy Machines, Hauppauge, N.Y., 15 S injection molder), usable to mold the composite into rectangular test pieces for analysis.

In the first step of a continuous process, walnut shells were reduced in size to a tight particle size distribution of between 3,000-5,000 microns using a knife mill. Further size reduction was accomplished using the ball attritor with 0.25-inch ceramic balls to reduce the particle size to a mean of 100 μm. Using a gravimetric feeder, the ground walnut shells were fed at constant rate of 0.55 kg h⁻¹ to the torrefaction reactor for heat treatment between 250-290° C. from feed to the die. Nitrogen gas was purged through the torrefaction module at 5 L min⁻¹.

Exiting the torrefaction reactor were two streams: solids and gases. Solid (torrefied biomass) yield was about 60 percent of the raw feedstock (wet basis, 6% initial moisture). The gas stream was diluted with air and purged. The torrefied biomass was fed directly into the compounder, along with metered recycled high-density polyethylene (HDPE) plastic.

The compounder was a single screw extruder module, operating at 180° C. and having a throughput of about 1.7 kg h⁻¹ of material. The gravimetric feeder for HDPE was set at 23 g min⁻¹. The resulting biomass-polymer composite had about 30% torrefied biomass by weight.

### Example 2: Characterization of Biomass-Polymer Composite

Biomass-polymer composite (BPC) produced by the above-described system and method was compared against similar material produced by the method described in Chiou, et al. (Torrefied Biomass-Polypropylene Composites, J. Appl. Polym. Sci. 2015). Notably, in Chiou, et al., the BPC is produced using a current standard method, where torrefied biomass is produced separately before being incorporated into the polymer, as opposed to the present method wherein the BPC is produced in a single coherent system and method.

Measured Properties

Several physical characteristics of the two different materials were measured, including tensile modulus, tensile strength, and percent elongation at break. The methods used for testing were the same as in Chiou, et al. (2015) to match as close as possible. The results of the testing are shown in Table 1 below. Several different concentrations of torrefied biomass from walnut shells (0%, 15%, 22%, and 35%) in polyethylene (as described above) were used to compare against the torrefied polypropylene and almond shells of Chiou. Torrefied biomass particle sizes used in the present method to create the below data was approximately 100 μm to compare with the 163 μm data from Chiou.

TABLE 1
Physical properties of Biomass-Polymer Composites

| | | | |
|---|---|---|---|
| Biomass | Tensile | Tensile Str | Elongation |
| (wt %) | Mod (MPa) | (MPa) | (%) |

Composite of Current Method

| | | | |
|---|---|---|---|
| 0 | 716.7 | 22.0 | 62.5 |
| 15 | 836.7 | 22.1 | 41.1 |
| 22 | 693.1 | 23.2 | 25.2 |
| 35 | 907.1 | 21.3 | 15.0 |

Composite of Chiou et al. (2015)^{a}

| | | | |
|---|---|---|---|
| 0 | 908.5 | 36.3 | 714.6 |
| 5 | 943.5 | 29.4 | 11.9 |
| 12.5^{b} | 951.6 | 27.0 | 9.4 |
| 20 | 917.2 | 23.3 | 8.2 |

^{a}Numbers taken from Chiou, et al. (2015), Table 1, 163 μm filler size
^{b}Numbers in this row were averaged from runs 6 and 10 in Table 1 of Chiou, et al.

In order to better visualize the above information, the data were normalized to compare against pure plastic (0% biomass), as shown in Table 2:

TABLE 2
Physical properties of Biomass-Polymer Composites (Normalized)

| | | | |
|---|---|---|---|
| Biomass | Δ Tensile | Δ Tensile | Δ Elongation |
| (wt %) | Mod (%) | Str (%) | (%) |

Composite of Current Method

| | | | |
|---|---|---|---|
| 0 | 100 | 100 | 100 |
| 15 | 117 | 101 | 66 |
| 22 | 97 | 106 | 40 |
| 35 | 127 | 97 | 24 |

Composite of Chiou et al. (2015)^{a}

| | | | |
|---|---|---|---|
| 0 | 100 | 100 | 100 |
| 5 | 104 | 81 | 2 |
| 12.5^{b} | 105 | 74 | 1 |
| 20 | 101 | 64 | 1 |

^{a}Original numbers taken from Chiou, et al. (2015), Table 1, 163 μm filler size
^{b}Original numbers in this row were averaged from runs 6 and 10 in Table
1 of Chiou, et al.

As can be seen in Tables 1 and 2 above, the material of Chiou has a drastic drop of elongation with the addition of any torrefied biomass, as compared to BPC produced by the current method, where up to 35% wt/wt % of torrefied biomass still allows for substantial elongation. Similarly, the tensile strength and tensile modulus data show significant differences between TBC produced by the current method and BPC produced according to prior-known methods.

Visual Differentiation

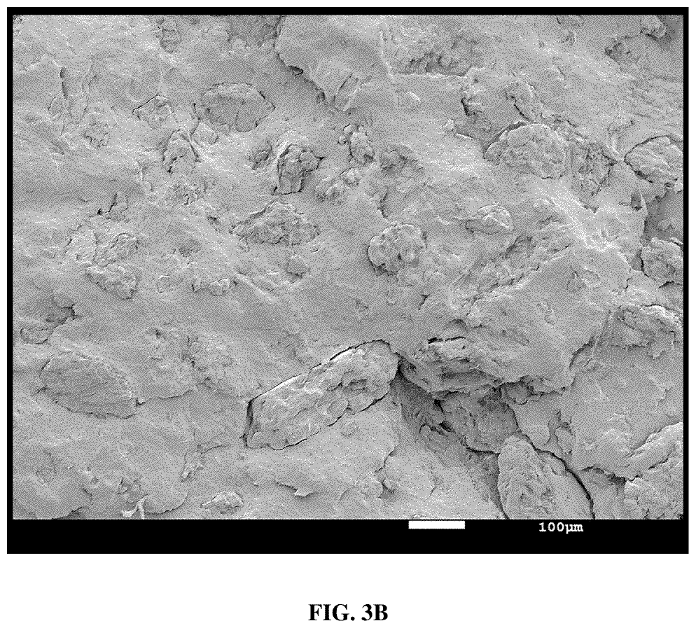

The BPC of the present invention was investigated under scanning electron microscopy (SEM), as can be seen in FIGS. 3A and 3B. The images show good adhesion between the torrefied biomass and the polymer. Note the contrast with FIG. 7 of Chiou, et al., where there are large shadow areas around the particulate matter. Though some shadow areas do appear in material produced according to the present invention, they are much smaller and fewer than those in material produced in the prior art.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1: A system for the production of a biomass-polymer composite, comprising:
a mill configured to accept a biomass input;
a torrefaction reactor; and
a compounder,
wherein the mill is configured to generate a particulated biomass from the biomass input, the particulated biomass having a particle size of between about 1 to about 1000 microns,
wherein the torrefaction reactor is configured to conduct a heat treatment of the particulated biomass, the heat treatment comprising exposing the particulated biomass to a temperature of between about 180 to about 650° C. to generate a torrefied biomass,
wherein the compounder is configured to combine the torrefied biomass with a plastic to generate the biomass-polymer composite, and
wherein the torrefaction reactor and the compounder are in functional communication with each other to permit the torrefied biomass to flow from the torrefaction reactor to the compounder without allowing the torrefied biomass to cool to a temperature below 100° C.

2: The system of claim 1, further comprising a first feeder disposed between the mill and the torrefaction reactor, wherein the first feeder is configured to provide a controlled flow of the particulated biomass into the torrefaction reactor.

3: The system of claim 1, further comprising a second feeder disposed between the torrefaction reactor and the compounder, wherein the second feeder is configured to provide a controlled flow of the torrefied biomass into the compounder.

4: The system of claim 1, wherein the mill comprises an attrition mill.

5: The system of claim 1, wherein the particulated biomass has a particle size of between about 1 to about 150 microns.

6: The system of claim 1, wherein the heat treatment has a duration of between about 1 to about 100 minutes.

7: The system of claim 1, wherein the torrefaction reactor is configured to conduct the heat treatment in a low-oxygen or oxygen-free environment.

8: The system of claim 1, wherein the compounder comprises an extruder.

9: The system of claim 1, wherein the compounder is configured to combine the torrefied biomass with the plastic in a melt blend at a temperature near the melting point of the plastic.

10: A method for the production of a biomass-polymer composite, comprising:
providing a biomass input;
reducing the particle size of the biomass input to create a particulated biomass;
conducting a heat treatment of the particulated biomass to create a torrefied biomass; and
combining the torrefied biomass with a plastic to create a biomass-polymer composite,
wherein the particulated biomass has a particle size of between about 1 to about 1000 microns,
wherein the heat treatment of the particulated biomass comprises exposing the particulated biomass to a temperature of between about 180 to about 650° C., and
wherein the torrefied biomass does not substantially cool prior to being combined with the plastic.

11: The method of claim 10, wherein the reducing of the particle size of the biomass input is conducted with an attrition mill.

12: The method of claim 10, wherein the particulated biomass has a particle size of between about 1 to about 150 microns.

13: The method of claim 10, wherein the heat treatment of the particulated biomass has a duration of between about 1 to about 100 minutes.

14: The method of claim 10, wherein the heat treatment is conducted in a low-oxygen or oxygen-free environment.

15: The method of claim 10, wherein the combining of the torrefied biomass with the plastic is conducted in an extruder.

16: The method of claim 10, wherein the combining of the torrefied biomass with the plastic is conducted in a melt blend at a temperature near the melting point of the plastic.

17: A biomass-polymer composite produced by the method of claim 10.
